(19) United States
(12) Patent Application Publication
(10) Pub. No.: US 2012/0195027 A1
(43) Pub. Date: Aug. 2, 2012

(54) ILLUMINATING SCISSORS AND METHODS OF USE

(75) Inventors: Corey Russ, Fayetteville, NC (US); John Bradley Gilpin, Bossier City, LA (US); Christopher Murphy, Vass, NC (US)

(73) Assignee: COMBAT MEDICAL SYSTEMS, LLC., Fayetteville, NC (US)

(21) Appl. No.: 13/018,699

(22) Filed: Feb. 1, 2011

(51) Int. Cl. B26B 13/00; B25B 23/18

(52) U.S. Cl. 362/119

(57) ABSTRACT

A durable and reliable illuminating scissor is disclosed herein having a cutting shear and a light source for illuminating the cutting area. The light source can be connected to a part of the cutting shear and can have an internal power source and light bulb. The light source can shine a visible, or other type of light, toward the cutting area to increase visibility for the user.

### TECHNICAL FIELD

This disclosure relates generally to the field of cutting instruments and specifically to medical scissors.

### BACKGROUND

Medical utility scissors are sometimes used during the initial treatment of patients, which may occur outside of a hospital, such as on the combat battlefield and in civil first-responder situations. For example, in military settings, military medics often carry utility scissors in their first aid kits or on their uniforms for quick access. Sometimes the patient must be treated in low light environments. Military operations often occur during the night or in low visibility environments such as in trenches or enclosed vehicles. When another soldier or civilian is injured, the medic must use the utility scissors in low light to cut the uniform or clothing away from the injured areas.

### SUMMARY OF THE DISCLOSURE

In some embodiments disclosed herein, scissors having a portable light source are provided herein for use in limited light environments. The scissors and light source can be lightweight, extremely durable, and easily operated while wearing gloves.

In accordance with some embodiments of the present application, the illuminating scissors can comprise a shear with a handle, the handle having at least one aperture through it, and further comprise a light source attached to the shear, the light source having a housing that contains at least a power source, light bulb and switch. The housing can have a curved portion that corresponds to the shape of the at least one aperture of the handle. The housing can be configured for easy and/or quick attachment and detachment from the shear. In some embodiments, the housing can be integrated into the handle.

In some embodiments, the scissor assembly can comprise a shear with a handle, the handle comprising at least one gripping region, and a light source attached to the shear, the light source comprising at least a portion with a shape that generally corresponds to the shape of the portion of the shear where it is attached.

In some embodiments, a method of using an illuminating scissor can comprise the steps of positioning the user's fingers on a handle of a shear, automatically activating a light source that is attached to the shear to illuminate a working area, removing the user's fingers from the handle, and automatically deactivating the light source. In some embodiments, positioning of the user's fingers on the handle can automatically activate the light source and removing the user's fingers from the handle can automatically deactivate the light source.

### BRIEF DESCRIPTION OF THE DRAWINGS

Specific embodiments and modifications thereof will become apparent to those skilled in the art from the examples provided in the detailed description herein having reference to the figures that follow, of which:

FIG. 1 is a schematic top perspective view of an example of an illuminating scissor according to an embodiment of the present application.

FIG. 2 is a schematic side elevation view of the illuminating scissor of FIG. 1.

FIG. 3 is a schematic side elevation view of the illuminating scissor of FIG. 1 with the cover of light source removed.

FIG. 4 is a schematic perspective view of detail 4 of FIG. 3.

FIG. 5 is a schematic side elevation view of an example of an illuminating scissor according to an alterative embodiment of the present application.

FIG. 6 is a schematic top perspective view of an example of an illuminating scissor according to another embodiment of the present application.

FIG. 7 is a schematic top perspective view of an example of an illuminating scissor according to another embodiment of the present application.

FIG. 8 is a schematic perspective view of the use of the illuminating scissor of FIG. 1.

### DETAILED DESCRIPTION OF SPECIFIC EMBODIMENTS

Scissors can be constructed of two elongate members secured together at a pivot point defined by a rivet, screw, or other pivoting union. On one side of the pivot point are handles, e.g., in the form of loops, which are used to hold and actuate the scissors. The other side of the pivot point can have elongate legs with at least one of the legs being sharpened into a blade. The opening and closing of the handles causes the opening and closing of the legs, which can cut through material by shearing the material between the two elongate legs of the scissor. Depending on the intended purpose of the scissors, the position of the pivot point, and the length of the handles relative to the legs can be altered to suit specific uses. For example, precise cutting instruments may have the pivot point offset closer to the end with the legs such that the blades are short and the handle is relatively long. Large movements of the handle cause small movements of the blades, resulting in precision cutting. Also, the long handles provide improved leverage to cut tough materials.

Scissors are often used in the medical field, such as for cutting human tissue during surgery, cutting suture threads, and cutting clothing off patients to access wounds. Medical utility scissors that are used to cut clothing or other obstructions from patients can have a rounded tip on the blades to prevent inadvertent puncture of the patient with the scissors. Sometimes, the scissors are angled at the pivot point for improved access to the material for quicker cutting.

Examples of scissors having light sources are described herein. None of these examples should be understood to limit the inventions recited in the claims. None of the structures, steps, or other features disclosed herein are essential or indispensible; any can be omitted in some embodiments. Some of the illuminating scissors disclosed herein can be particularly advantageous for use in rugged and abusive combat or military environments, and can be configured for simple integration with existing equipment.

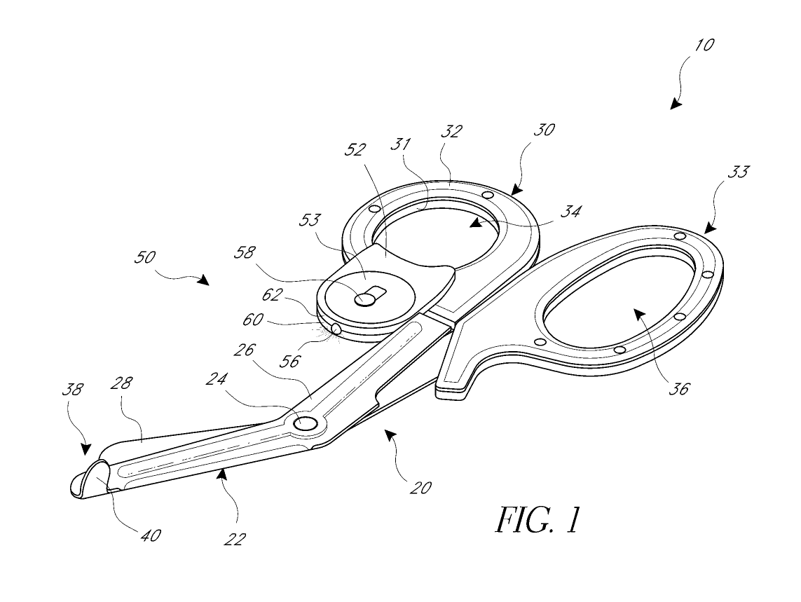

In this application, the term “distal” is used to describe the direction toward the cutting side of the scissors and the term “proximal” is used to describe the direction toward the handles of the scissors 10. In FIG. 1, the distal portion is toward the distal legs 28 and the proximal portion is toward the proximal legs 26.

Illuminating scissors having desirable features and advantages will now be described with reference to the figures. The term “illuminating scissors” is used throughout to refer to scissors with one or more light sources. Although the following description is provided in the context of an example of a medical utility shear, the features of the illustrated scissors can provide advantages in other types of cutting devices as well. Furthermore, although some portions of the following description is provided with reference to scissors, it is understood by one of skill in the art that the light source can be applied to many other types of utility devices, such as syringes, razors, firearms, pliers or wrenches. For example, in some embodiments, a light source can be attached to a syringe to illuminate the injection site on a patient in low-light environments.

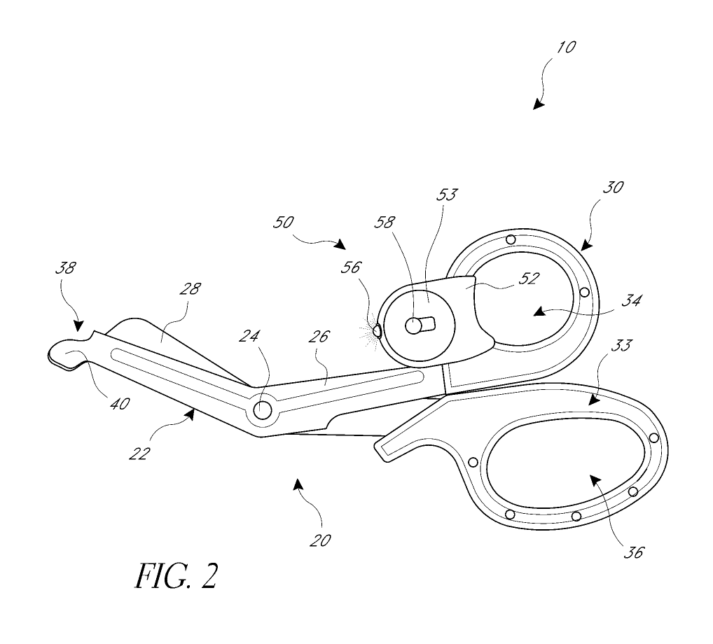

FIGS. 1 and 2 illustrate an embodiment of the illuminating scissor 10 that includes a medical utility shear 20 and a light source 50. The light source 50 can be configured to secure to the utility shear 20, or can be integrated into the design of the scissors. In the illustrated embodiment, the light source 50 is attached to the first handle 30 of the utility shear 20.

As illustrated in FIGS. 1 and 2, the medical utility shears 20 can have two elongate members 22 that are secured together at a pivot point 24 defined by a rivet, screw, or other pivoting union. On the proximal side of the pivot point are the proximal legs 26 of the elongate members 22 and on the distal side of the pivot point 24 are distal legs 28 of the elongate members 22. The elongate members 22 can be made of a durable, strong material that is suitable for cutting, such as steel, aluminum, rigid plastics, or composites.

Handles 30, 33 can be disposed on the proximal ends of the proximal legs 26. The handles 30, 33 can be molded onto the proximal legs 26 or attached to the proximal legs 26 through any functional attachment, such as with fasteners, brads, adhesives, sonic welding, or snap-fits. For example, as illustrated in FIG. 1, the first handle 30 is made of two layer pieces 31, 32 that are joined together with fasteners around the periphery of the handle 30. The proximal leg 26 is retained between the layers 31, 32 of the handle 30.

In some embodiments, the handles 30, 33 can be made of rigid plastics, such as high density polyethylene. In some embodiments, the handles 30, 33 can be made of other materials, such as rigid rubber, composites or metals. The handles 30, 33 can be in the shape of complete or partial loops with apertures 34, 36 for accepting the fingers of the user. In the embodiment illustrated in FIGS. 1 and 2, the first handle 30 has a smaller loop than the second handle 33. The first handle 30 can be configured to accept the user's thumb through the first aperture 34 and the second handle 33 can be configured to accept at least two fingers through the second aperture 36 of the second handle 33. The user can open and close his/her hand to actuate the scissors.

The distal legs 28 can extend from the pivot point 24 and at least one of the legs 28 can be sharpened into a blade. For enhanced performance, both legs 28 can be sharpened. The opening and closing of the handles 30, 33 causes the opening and closing of the distal legs 28, which cuts through material by shearing the material in-between the distal legs 28. The sharpened edge of at least one of the legs can cut through the material. In some embodiments, the distal legs 28 can be reinforced or hardened, such as through heat treatment, to enhance the distal legs' 28 ability to cut through material. As illustrated in FIGS. 1 and 2, the distal tips 38 of the distal legs 28 can be rounded to prevent inadvertent puncture of the patient with the utility shears 20. In some embodiments, the distal tips 38 can have a flat member 40 extending transversely from the longitudinal axis of the distal legs 38, as illustrated in the figures. The flat member 40 can provide a guide to help control the scissors when cutting along the patient's body.

Medical utility shears 20 are often used to cut clothing, straps, bandages or other obstructions from patients to access the injured area. In some embodiments, the scissors can be angled at the pivot point, which can help improve operation of the shears 20 when cutting along a surface. As illustrated in FIG. 2, the proximal legs 26 of the shears 20 do not form a straight line with the distal legs 28, but rather form an angle with the distal legs 28. Since the handles 30, 33 are not positioned in the cutting plane of the distal legs 28, the handles 30, 33 can be opened and closed freely without obstruction from the cutting surface. For example, the angled shears 20 can be used to cut clothing off a patient. The angle of the shears 20 allows the user to cut along the patient's body while providing clearance for the opening and closing action of the handles 30, 33 such that the motion of the handles 30, 33 is not impeded by the patient's body.

With continued reference to FIGS. 1 and 2, the illuminating scissors 10 can have a light source 50 attached to, and/or integrated into, the medical utility shears 20. In the illustrated embodiment, the light source 50 has a housing 52 that can attach to the first handle 30. In some embodiments, the light source 50 can be attached to other parts of the utility shears 20, as discussed below. The light source 50 can have an internal power source 54 and a light bulb 56 aimed at the working area of the shears 20. A switch 58 can be accessed from the exterior of the housing 52 to turn the light on and off.

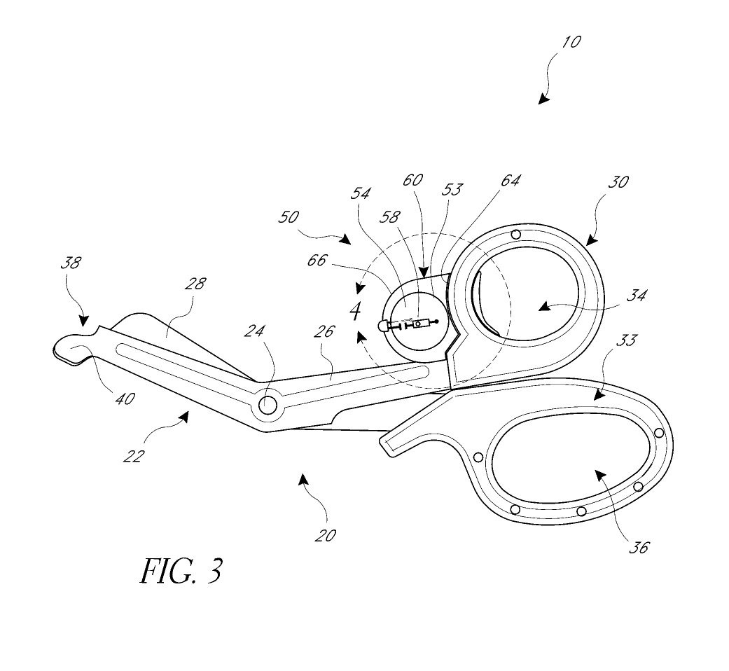

The housing 52 of the light source 50 can be configured to contain the components of the light source 50 and couple to the utility shear 20. In the embodiment illustrated in FIG. 3, the housing 52 has two portions 60, 62 that couple together around the first handle 30. The first portion 60 can have structures, such as hooks and slots, which can lock to complementary structures on the second portion 62 to mount to the first handle 30. In some embodiments, the first portion 60 and second portion 62 can have other functional couplers, such as fasteners, adhesives and sonic welding.

One or both portions 60, 62 can have a hollow 64 that can be shaped to correspond with the contours of the first handle 30. The two portions 60, 62 can have other structures to hold the other components of the light source 50. In some embodiments, the two portions 60 can contain the power source 54, such as a battery. The housing 52 can have a removable cover 53 to facilitate replacement of the battery. In some embodiments, the light source 50 can have electrical leads extending from the housing that can be connected to an external power source. A light bulb 56 can be coupled to the housing 52 such that a portion of the light bulb 56 lies outside the housing 52 to shine a light toward the working area.

In some embodiments, a switch 58 can be disposed on the side of the first portion 60 and/or second portion 62 to electrically connect and disconnect the power source 54 to the light bulb 56. In some embodiments, the switch 58 can be configured so that it can be activated even by large fingers or gloved hands. For example, in the illustrated embodiments, the switch 58 is a protrusion that is simply shifted in one direction to activate the light and shifted in the opposite direction to deactivate the light. In some embodiments, the light bulb 56 can be activated automatically when the user places his/her fingers through the apertures 34, 36. For example, the switch can be a lever that extends into the apertures 34, 36 and is actuated as the fingers of the user are placed through the apertures 34, 36. In some embodiments, the switch can be a pressure sensor on the housing 52 that can be actuated when the user's fingers are placed on the pressure sensor. In some embodiments, the switch can be a push button that can be pressed once to activate the light source and pressed again to deactivate the light source.

In some embodiments, the switch 58 can be configured to be operated with the same fingers that are positioned through the apertures 34, 36 of the shear 20. This configuration advantageously allows, but does not require, the user to operate the illuminating scissor with only one hand, freeing the user's other hand for other task, such as holding the material to be cut or applying a pressure dressing.

With continued reference to FIG. 2, the portion of the housing 52 that wraps around the first handle 30 is advantageously unobtrusive so that it does not obstruct the opening of the first aperture 34. In some embodiments, a portion of the housing 52 can have a curved shape where it attaches to the handle, which can correspond to the shape of the first aperture 34 of the handle 30. The curved shape of the housing 52 can help to avoid obstructing the space within the apertures 34, 36 so that the fingers of the user can be placed through the apertures 34, 36 without obstruction from the light source 50. In some embodiments, one or more surfaces of the housing 52 of the illumination source can taper, curve, bend, or turn to generally correspond to the shape of the surrounding or adjacent portion of the handle or other component of the scissor. In some embodiments, the housing can include straps that can wrap around the handle to secure to the shear 20. In some embodiments, the housing can be secured to the shear 20 without wrapping around loops of the handles 30, 33. For example, the first portion 60 and second portion 62 of the housing 52 can have a compression grip to clamp onto the shear 20. In some embodiments, the housing 52 can be fastened to the shears 20 with removable or non-removable fasteners, such as screws, bolts, rivets, etc.

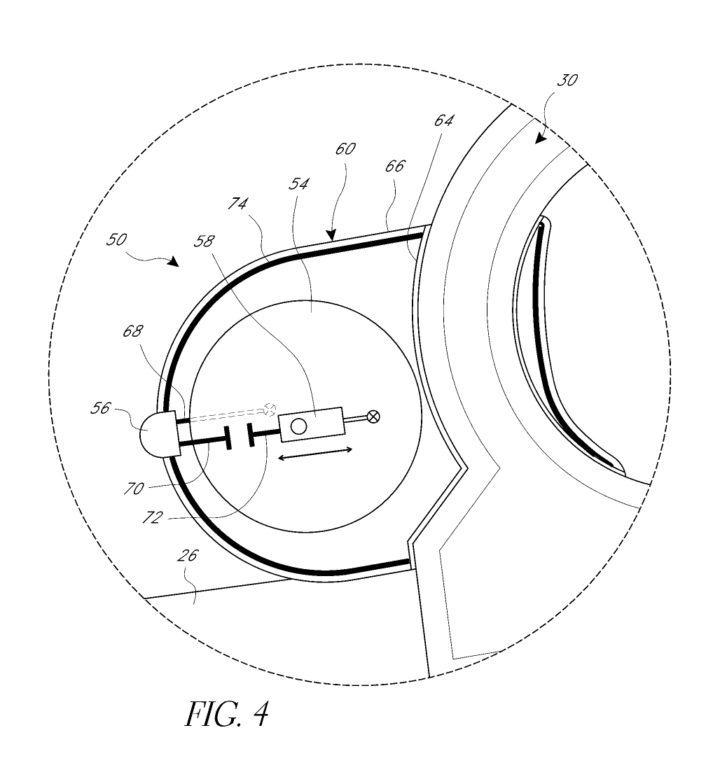

FIG. 4 illustrates a non-limiting example of the internal components of the light source 50. In the illustrated embodiment, a power source 54 or battery is contained in the middle of the housing 52. In some embodiments, more than one battery can be stacked, wherein the negative side of one battery contacts the positive side of the adjacent battery so that the batteries are in series to provide the proper voltage to the light bulb 56. The light bulb 56 can be disposed along the periphery 66 of the housing 52 so that at least part of the light bulb 56 is exposed externally of the housing 52. A first lead 68 of the light bulb 56 is in electrical contact with a positive or negative terminal of the battery. The second lead 70 of the light bulb 56 extends toward the switch 58. The switch 58 can have a jumper 72 that is connected to a terminal of the battery. The switch 58 can connect with a terminal of the battery of opposite polarity to the terminal connected to the first lead 68. For example, if the first lead 68 is connected to a positive terminal of the battery, then the switch 58 can connect with a negative terminal of the battery, and vice-versa. The jumper 72 can also contact the second lead 70 of the light bulb 56 when the switch is activated. Thus, in the activated configuration, the jumper 72 completes the circuit so that electrical power is delivered to the light bulb 56. When the switch 58 is in the deactivated configuration, the second lead 70 does not make contact with the jumper 72 and the circuit is broken to turn the light bulb 56 off. Although an embodiment of the internal components and operation of the light source is described herein, it is to be understood that any of a variety of configurations of internal components and operation methods for completing a circuit are also envisioned, as is apparent to those of skill in the art in view of the disclosure herein.

Different light bulbs 56 can be selected for different situations. In some embodiments, the light bulb 56 can be a light emitting diode (LED), which consumes less power than an incandescent light bulb. In some embodiments, the light bulb can emit visible light, while in other embodiments the light bulb can emit infrared light that can be seen through night vision goggles. In some embodiments, the light source 50 can have one or more light bulbs and can be configured to emit visible light and/or infrared light, depending on the situation.

In some embodiments, the light source 50 can be advantageously strong, durable and reliable to withstand the abuse that the illuminating scissors may experience in the field. For example, in military settings, military medics often carry backpack type medical kits made of durable cloth-like materials that can contain the illuminating scissor 10. These soft kits are often subject to severe stresses associated with the rigors of warfare, where the individual carrying the soft kit is often running along walls, diving on the ground, and generally engaging in rigorous physical activity that impacts the items in the kit. In some situations, the illuminating scissor 10 may be carried on the uniform or body armor of the medic. Thus, the illuminating scissor 10 can be subjected to abuse such as impacts, moisture and dirt. The illuminating scissor 10, and particularly the light source 50, can be made of strong material that can withstand the abuse. For example, the housing 52 of the light source 50 can be made of a strong plastic material, such as high density polyethylene, and the electrical contacts can be made of a rust-resistant metal, such as aluminum. In some embodiments, the housing 52 of the light source 50 can include a seal 74 or o-ring between the first portion 60 and second portion 62 to create a protective, watertight seal between the portions, as illustrated in FIG. 4.

In some embodiments, the light source can be configured to attach to a plurality of different types of scissors. For example, the light source can have a universal clamp that can attach to multiple handles of scissors. The universal compatibility of the light source advantageously allows the light source to be attached to common scissors, enabling the light source to be used with existing equipment.

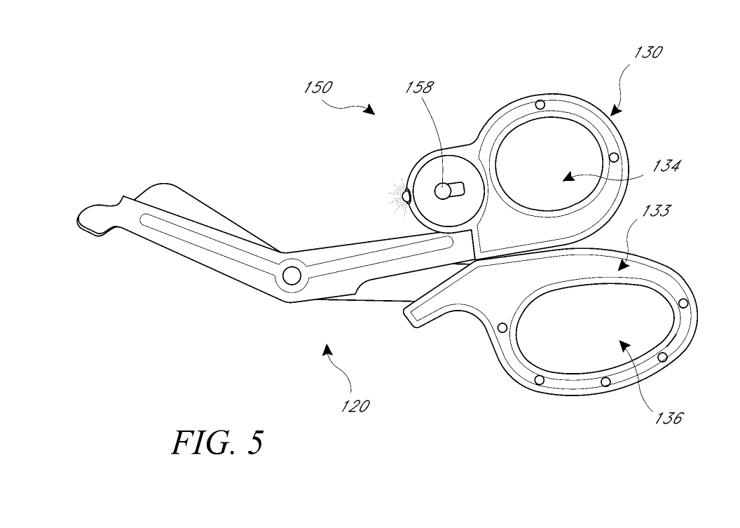

In some embodiments, the light source can be integrated into the design of the utility shear. For example, as illustrated in FIG. 5, the integrated light source 150 can be integrated into the first handle 130 of the utility scissor 120. The integrated light source 150 can be disposed between the two layer pieces of the first handle 130, wherein the components of the light source 150 are contained by the two layer pieces instead of a separate housing. The switch 158 can be positioned on the side of one or both of the layer pieces within easy access of the user. As described above, in some embodiments, the switch can be positioned so that it can be activated when the medical personnel positions his/her fingers through the apertures 134, 136 of the handles 130, 133. An integrated light source 150 can advantageously reduce the number of parts for the illuminating scissor 10 and can provide an integrated, finished appearance.

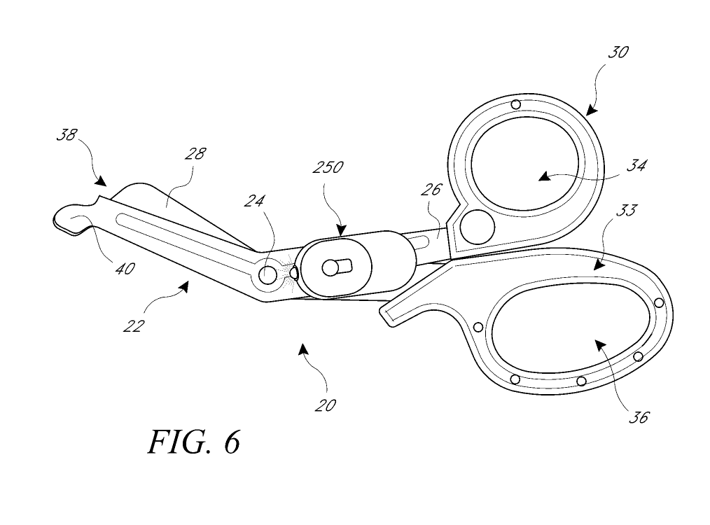

In some embodiments, the light source can be secured to other locations on the utility shear 20. For example, the light source 250 can be configured to attach to a proximal leg 26, as illustrated in FIG. 6. In another example, the light source can attach to the distal legs 28. In other embodiments, the light source can attach to any other portion of the utility shear 20.

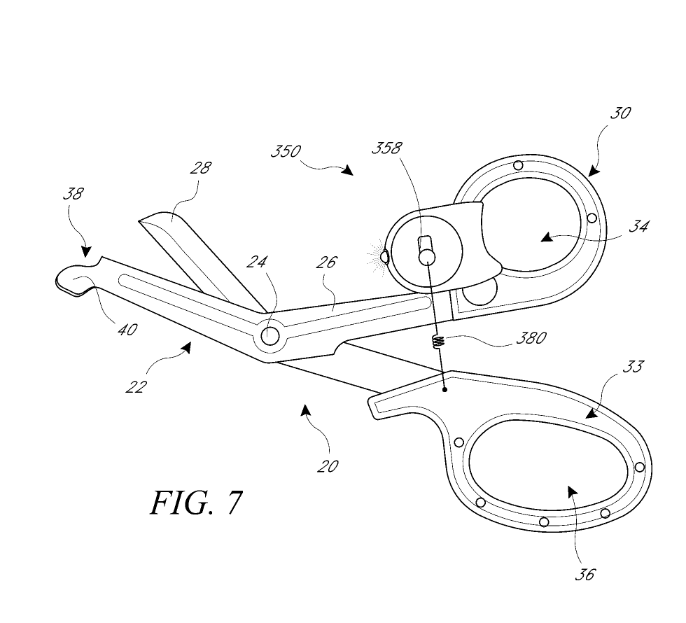

In an example of a method of use, first the illuminating scissors 10 are pulled out. In some embodiments, the user can actuate the switch 58 to activate the light source 50 and then position his/her fingers in the first aperture 34 and second aperture 36 of the handles 30, 33. In other embodiments, the user can position his/her fingers in the apertures 34, 36 and then activate the light source 50. In some embodiments, the user can activate the light source 50 while his/her fingers are positioned in the apertures 34, 36. In some embodiments, the light bulb 56 can be activated automatically when the user places his/her fingers in the apertures 34, 36, as described above. In some embodiments, the switch can be configured to be actuated when the elongate members 22 of the utility scissors 20 are opened. For example, the light source 350 can be positioned on one proximal leg and the switch 358 can be connected to the other proximal leg so that the separation of the proximal legs 26 can actuate the switch 358, as illustrated in FIG. 7. The switch 358 can be connected to the proximal leg with a rigid rod or other rigid member. In some embodiments, the switch 358 can be connected to the proximal leg with a spring 380 or a damper. The illumination module can be configured to provide a delay before the deactivation of the switch 358 after the legs are closed for a short period. The delay can advantageously help prevent the light source 350 from turning on and off repeatedly from the actuation of the scissors during use.

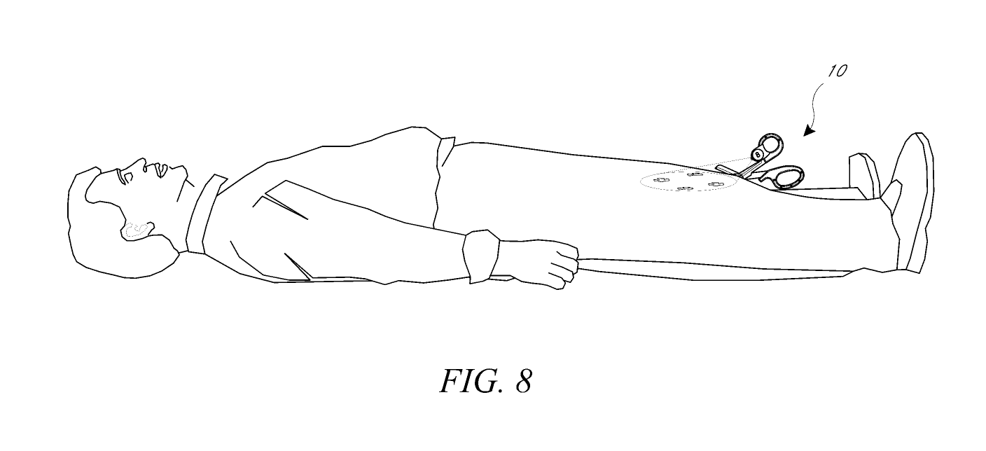

With reference to FIG. 8, the activated light source 50 can be aimed at the target cutting area to illuminate the distal legs 28 and the material to be cut. After the material is cut, the user can remove his/her fingers from the illuminating scissors 10. When the user removes his/her fingers, virtually immediately or after a delay, the switch can be deactivated and the light source 50 can turn off. In some embodiments, the light source 50 can turn off after a predetermined length of time to help prevent the power source from being drained of energy in case the user fails to deactivate the switch.

Although certain embodiments, features, and examples have been described herein, it will be understood by those skilled in the art that many aspects of the methods and devices illustrated and described in the present disclosure may be differently combined and/or modified to form still further embodiments. For example, any component of the illuminating scissor illustrated and described above can be used alone or with other components without departing from the spirit of the present invention. Additionally, it will be recognized that the methods described herein may be practiced in different sequences, and/or with additional devices as desired. Such alternative embodiments and/or uses of the methods and devices described above and obvious modifications and equivalents thereof are intended to be included within the scope of the present invention. Thus, it is intended that the scope of the present invention should not be limited by the particular embodiments described above, but should be determined only by a fair reading of the claims that follow.

The following is claimed:

1. An illuminating scissor comprising:
a shear with a handle, the handle comprising at least one aperture through it; and
a light source attached to the shear, the light source comprising a housing that contains at least a power source, light bulb and switch;
wherein the housing has a curved portion that corresponds to the shape of the at least one aperture of the handle.

2. The illuminating scissor of claim 1, wherein the light bulb emits infrared light.

3. The illuminating scissor of claim 1, wherein the light bulb emits light that is in the visible spectrum.

4. The illuminating scissor of claim 1, wherein the switch is a slide that is pushed in one direction to turn the light source on and pushed in the other direction to turn the light source off.

5. The illuminating scissor of claim 1, wherein the switch is a push button that is depressed once to turn the light source on and pushed again to turn the light source off.

6. The illuminating scissor of claim 1, wherein the switch is configured to turn on the light source when the user holds the shear through the handle and turns off the light source when the user releases the shear.

7. The illuminating scissor of claim 1, wherein the illuminating scissor is configured to be operated by one hand.

8. The illuminating scissor of claim 1, wherein the power source is a battery.

9. The illuminating scissor of claim 1, wherein the light source is configured for easy attachment and detachment from the shear.

10. The illuminating scissor of claim 1, wherein the housing is integrated into the handle.

11. The illuminating scissor of claim 1, wherein the housing comprises a hollow that accepts at least a portion of the handle to secure to the handle.

12. A scissor assembly comprising:
a shear with a handle, the handle comprising at least one gripping region; and
a light source attached to the shear, the light source comprising at least a portion with a shape that generally corresponds to the shape of the portion of the shear where it is attached.

13. The scissor assembly of claim 12, wherein the light source is attached to the handle of the shear.

14. The scissor assembly of claim 12, wherein the shear further comprises distal legs with at least one blade, wherein the light source is attached to the distal legs.

15. The scissor assembly of claim 12, wherein the shear further comprises proximal legs attached to the handle, wherein the light source is attached to the proximal legs.

16. A method of using an illuminating scissor, the method comprising the steps of:
positioning the user's fingers on a handle of a shear;
automatically activating a light source that is attached to the shear to illuminate a working area;
removing the user's fingers from the handle;
automatically deactivating the light source.

17. The method of using an illuminating scissor of claim 16, wherein positioning the user's fingers on the handle activates the light source and wherein removing the user's fingers from the handle deactivates the light source.

18. The method of using an illuminating scissor of claim 16, wherein the step of automatically activating the light source comprises a switch that is slid in a direction and the step of automatically deactivating the light source comprises sliding the switch in the opposite direction.

19. The method of using an illuminating scissor of claim 16, wherein the step of automatically activating the light source comprises a button that is pressed and the step of automatically deactivating the light source comprises releasing the button.

20. The method of using an illuminating scissor of claim 16, wherein the step of deactivating the light source comprises a timer that deactivates the light source after a period of time.
